(19) United States
(12) Patent Application Publication
(10) Pub. No.: US 2009/0063871 A1
(43) Pub. Date: Mar. 5, 2009

(54) Method and device for managing proprietary data format content

(76) Inventors: Dirk Frijters, Witten (DE); Andree Ross, Luenen (DE); Dirk Gaschler, Wermelskirchen (DE)

Correspondence Address: MORGAN & FINNEGAN, L.L.P., 3 WORLD FINANCIAL CENTER, NEW YORK, NY, 10281-2101, US

(21) Appl. No.: 11/665,098

(22) PCT Filed: Oct. 11, 2004
(86) PCT No.: PCT/IB04/03303

§ 371 Date: Nov. 13, 2008

(51) Int. Cl. H04L 9/06; G06F 21/00

(52) U.S. Cl. 713/193; 726/26

(57) ABSTRACT

The invention provides a method for generating a protected data object from an original content by means of digital rights management (DRM) protection techniques, wherein said original content has a proprietary data format. Further, a method for providing a proprietary data format content included in a protected data object having a MIME-type field is proposed, wherein said protected data object is generated by means of digital rights management (DRM) techniques.

The invention relates generally to methods for generating a protected data object from an original content, wherein the original content has a proprietary data format. Particularly the present invention relates to a method for providing the proprietary data format content included in protected data object. Further, the invention proposes a server unit and a mobile unit adapted to deal with said protected data object.

Though the spreading use of media content in digital form has many advantages regarding among others quality and ease of use, it also poses one problem, which resides in the chance of lossless duplication associated with digital content. Since it is easy to copy digital information, copyright infringement has become a great threat to content owners.

Presently, there are many different concepts and methods available, which are provided to deal with and generate protected digital content. The digital content that has to be protected corresponds for instance, but is not limited to, to usual software applications or other conceivable content, like digital music, pictures etc. Over the time, software applications on personal computers, mobile phones or gaming consoles (in the following called “system”) have become more and more precious and an attractive business has evolved around different kinds of applications on those systems. An example is the gaming business for mobile or stationary gaming devices. If a software application has been acquired for a particular device, a content protection technique has to ensure that this software application is only running on that specific device and cannot be copied to another device. It has to ensure that the application code cannot be manipulated (e.g. by exchanging code instructions) to protect the data integrity. A license is usually required to acquire and use the code. The term “license” summarizes the required software components that make the protected software run on a device. Content-protected software cannot be used without a valid license on the device.

Thus a protection for digital content was developed, the so called “digital rights management” (DRM). DRM utilizes encryption for the protection of media content. The principles of DRM are associating usage rules with the digital content and further enforcing these rules. The raw digital information is encrypted and usually specifically assigned to a predetermined device. Consequently, the content data cannot any longer be duplicated or without any restrictions be copied. This makes it possible for the provider of said digital content to restrict and suppress the undefined or illegal distribution of licensed content. The expression “digital content” summarizes usual content, which is well known on the market such as: ringing tones, pictures and logos, Java and Symbian applications, MIDI ring tones or even complex software applications or video clips. These issues are defined by the Open Mobile Alliance (OMA) and are provided for standardization of the usage of mobile-centric content.

DRM allows the control of usage of downloaded media objects and allows the content providers to define rules on how the content should be generally used. It makes it possible to sell the rights to use the media data rather then the media object himself. The rights can be delivered to the consuming device by downloading them together with the content or by sending the rights object separately from content. The OMA DRM system introduces three possible content delivery methods: forward-lock, combined delivery and separate delivery. The first two mentioned methods need to package content, together with a rights object, into a DRM message. The message may be delivered to the device using e.g. the OMA download mechanism (not part of this description).

The third method mentioned above is the separate delivery case. In this case the content provider needs to convert the plaintext media object into DRM content format. Said conversion includes symmetric encryption of the content making the DRM protected content useless to parties not having access to the Content Encryption Key (CEK). Thus, the content may be delivered via insecure transport. The rights object has to be separately delivered via secure transport like e.g. WAP push. However, the separate delivery is more secure than the first mentioned methods because it impedes to simply steal the content. Further information about the mentioned DRM methods are depicted in detail in the OMA DRM specification.

The state of the art offers lots of software tools for providing protection of digital content in accordance with the OMA DRM specification. These tools are called usually “Content Publishing Toolkits” and they shall provide the content provider with a user friendly software kit, which makes possible generating protected content into encrypted DCF-format (DRM content format).

The OMA Digital Rights Management specifies exactly the form for the DCF data object. In addition to the encrypting (see description above) the media object, also called DRM content format object (DCF), supports metadata such as:
Original content type of the media object;
Unique identifier for this DRM protected media object to associate it with rights;
Information about encryption details;
Information about rights; etc.

The OMA in the version of November 2003 exactly defines the content format for protected DRM content.

The OMA DRM uses the Multipurpose Internet Mail Extensions (MIME) media types which are defined in the RFC 2046 standard for identifying the content type. Generally, the MIME-type field of a file is used to identify which kind of data said file contains. The information included in the MIME-type is used to invoke the proper application intended to deal with the data, e.g. if the data is a picture, the image viewer is to be started. In the context of OMA DRM the content type field that is mentioned in the itemization above must define the original MIME-type (or MIME media type) of the actual DRM protected content, i.e. what content type the result of a successful decryption of the included encrypted data represents. However, the content of the MIME-field is useful for an invoked DRM agent on the device side that wants to deal with the protected content.

The state of the art defines MIME-types just for standardized data and not for proprietary data. This means that it is not possible to protect proprietary data by means of DRM techniques. But this is exactly what is needed if DRM should be used to protect general application, for instance games, against illegal copying or similar. Games or other applications make heavily use of proprietary (or arbitrary) formats for images, level or map data in case of games. Level and map data usually describe the area where for instance a character of the game makes his movements.

The state of the art defines DRM protection only for data possessing a valid MIME-type field. This invention should enable DRM protection of content even if the content possesses a proprietary or arbitrary data format. This means that present invention should be usable for proprietary data or files, even if they do not have a valid MIME-type field or a valid file extension.

According to a first aspect of the present invention, a method for generating a protected data object from an original content by means of digital rights management (DRM) protection techniques, according to claim 1, is provided. The original content has a proprietary (or arbitrary, respectively) data format. After obtaining said original content an encryption of said content follows that results in an encrypted content. Then follows the creation or generation of a header portion of said protected data object associated with said encrypted content, said header portion comprising information relating to said original content, and having a MIME-type field, wherein said MIME-type field defines at least one application capable to process said original content. Afterwards a blank entry is assigned to said MIME-type field of said header portion. The blank MIME-type field is dedicated for indicating the existence of a proprietary data format of said original content. Finally, the protected data object is generated by combining said header portion and said encrypted content, to be included in a body portion of said protected data object.

It is preferred that a rights entity associated with the original content is generated. The rights entity may be provided for further usage. This is a step used by content providers to distribute protected and licensed content to the users.

The original content may correspond to a software application, which is adapted to run on a mobile terminal device. This issue is advantageously for providing applications to be used on mobile devices like i.e. mobile phones.

It is preferred that said protected content is freely distributable from said mobile terminal device to a plurality of mobile terminal devices. This enables the distribution of said protected content.

According to another aspect of the present invention, a method for providing a proprietary data format content included in a protected data object having a MIME-type field is provided. Said protected data object is generated by means of digital rights management (DRM) techniques. Said method for providing proprietary comprises the steps of firstly receiving a request from a data-requesting application for obtaining the data included in said protected data object and subsequently checking the content of said MIME-type field in the protected data object. Subsequently it should be determined whether said MIME-type field of said protected data object is blank. The blank MIME-type field indicates the existence of proprietary data format. Further follows the extraction of an encrypted content included in a body portion of the protected data object and additionally decrypting of said encrypted content resulting in said proprietary data format content. Finally, the proprietary data format content is provided to the data-requesting application.

It is preferred that said encrypted content processed with respect to a previously obtained rights entity that is associated with said protected data object. This enables a controlled usage of the original content which has been previously encrypted by a content provider.

According to another aspect of the present invention a computer program for handling protected content is provided, comprising program code sections for carrying out the steps of anyone of the aforementioned claims, when said program is run on a computer, a microprocessor based device, a terminal, a network device, a mobile terminal, or a portable communication enabled terminal. Special software is essential for the invention, to provide a closed system on either side of the process.

According to another aspect of the present invention a computer program product for handling protected content is provided, comprising program code sections stored on a machine-readable medium for carrying out the steps of anyone of the aforementioned claims, when said program product is run on a computer, a microprocessor based device, a terminal, a network device, a mobile terminal, or a portable communication enabled terminal.

According to another aspect of the present invention a software tool for handling protected content is provided, comprising program portions for carrying out the operations of any one of the aforementioned claims, when said program is implemented in a computer program for being executed on a microprocessor based device, processing device, a terminal device, a network device, a mobile terminal, or a portable communication enabled terminal.

According to another aspect of the present invention a computer data signal is provided, embodied in a carrier wave and representing a program that instructs a computer to perform the steps of the method of anyone of the aforementioned claims.

According to an embodiment of the invention a server unit for generating a protected data object from an original content by means of digital rights management (DRM) protection techniques is provided, wherein said original content has a proprietary data format, comprising:
means for obtaining said original content;
a module for encrypting said original content resulting in an encrypted content;
a module for generating a header portion of said protected data object associated with said encrypted content, said header portion comprising information relating to said original content, having a MIME-type field, wherein said MIME-type field defines at least one application capable to process said original content;
a module for assigning a blank entry to said MIME-type field of said header portion, wherein said blank MIME-type field is dedicated for indicating the existence of proprietary data format of said original content; and
a module for generating said protected data object by combining said header portion and said encrypted content, to be included in a body portion of said protected data object.

According to an embodiment of the invention a mobile unit for providing proprietary data format content included in a protected data object having a MIME-type field is provided, wherein said protected data object is generated by means of digital rights management (DRM) techniques, comprising:
a module for receiving a request from a data-requesting application for obtaining the data included in said protected data object;
a module for checking the content of said MIME-type field in said protected data object;
a module for determining whether said MIME-type field of said protected data object is blank, wherein said blank MIME-type field indicates the existence of proprietary data format;
a module for extracting of an encrypted content included in a body portion of said protected data object and for decrypting said encrypted content resulting in said proprietary data format content; and
a module for providing said proprietary data format content to said data-requesting application.

In the following, the invention will be described in detail by referring to the enclosed drawings in which:

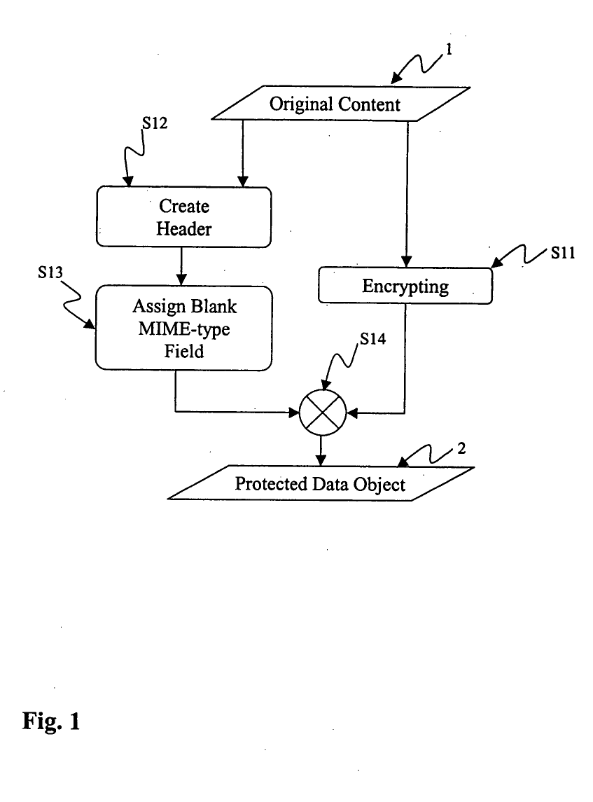

FIG. 1 is a flow chart representing the generation of protected content;

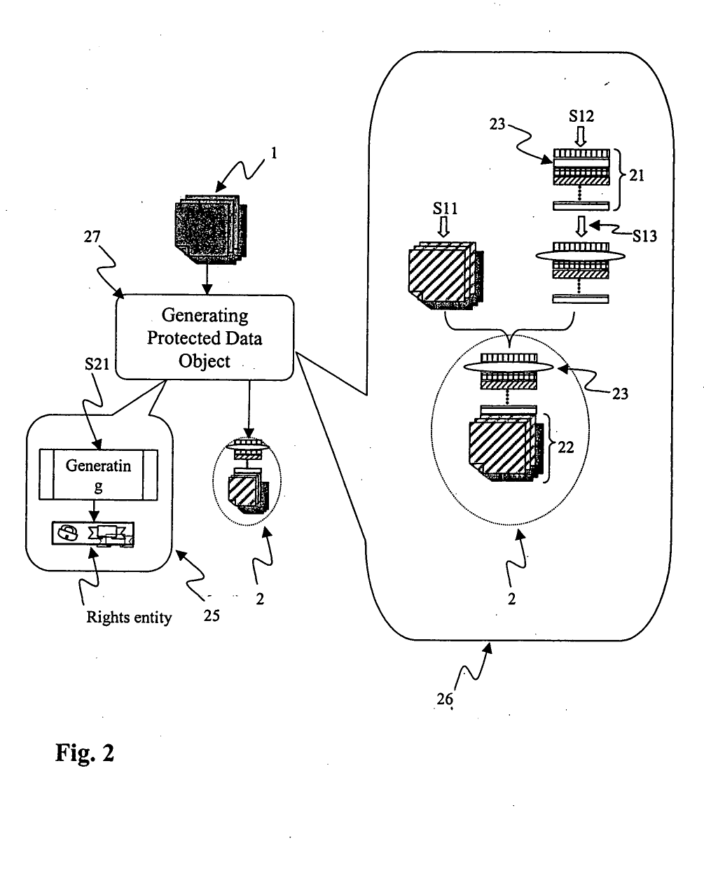

FIG. 2 depicts the exact data flow and exemplarily shows the header creation;

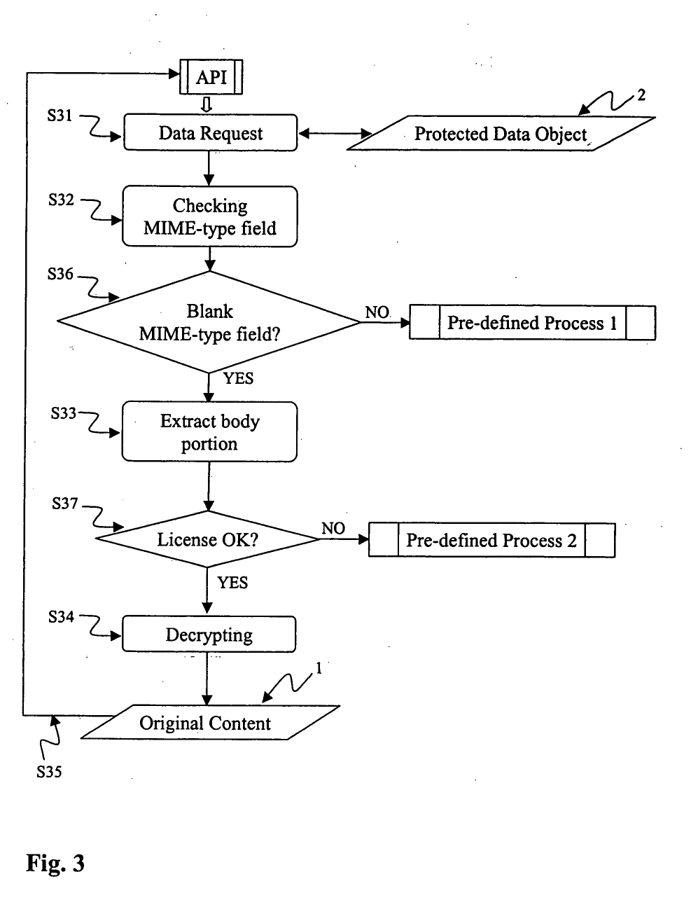

FIG. 3 is a flow chart representing the providing of data that is included in a protected data object;

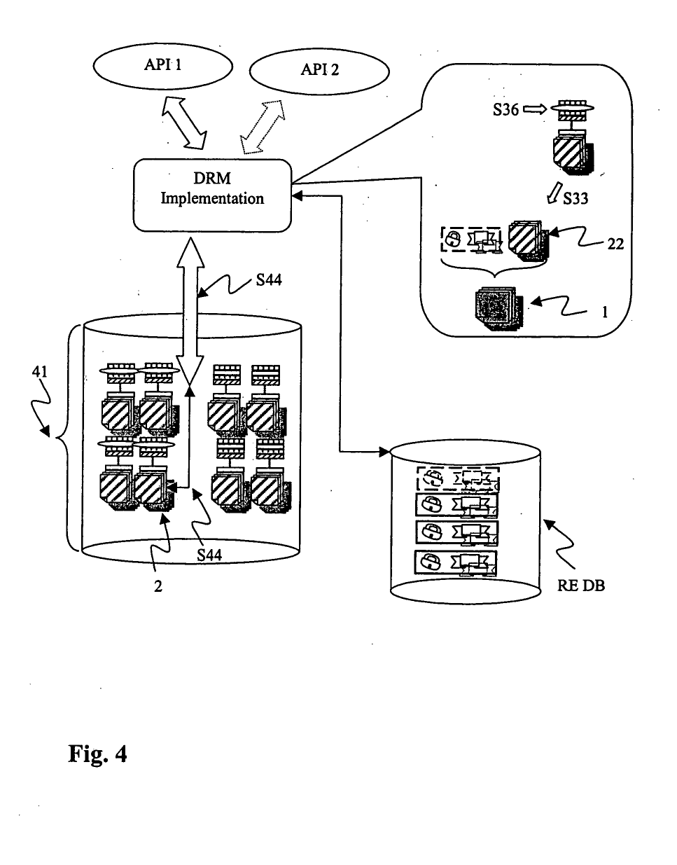

FIG. 4 shows in detail the method generally shown in FIG. 3.

FIG. 1 represents the generation of a protected data object in accordance with the present invention. The starting point corresponds to a package symbolized by block 1 and representing the original content. The original content may be any kind of digital data, like software applications, games, pictures etc. The present invention relates particularly to the generating of protected data objects from proprietary data, which is internally used by software applications e.g. games. In the operation S12 a header corresponding to the original content is provided. The header portion is necessary for providing the user side with information relating to the processed steps on the content generation side. The user side correspond for instance to a mobile phone who wants to use the protected data object. As aforementioned, the generating of said protected data object is done by means of DRM protection techniques. The created header corresponds to the header that is specified by the Open Mobile Alliance in connection with DCF data. A field defining the MIME-type of the original content 1 is included in the header portion. The exact definition of the other header elements may be found in the OMA DRM specification of November 2003.

The creating of the entire header portion is followed by the operation S13. This operation is an important step of the present invention and it assigns to the MIME-type field a blank value. After processing the operations S12 and S13 a DCF header in accordance with the present invention is provided. The operation S11 that may run in parallel to S12 and S13 provides the encryption of the original content. As mentioned above a symmetric encrypting technique may be provided by usage of the CEK-key. Information relating to the encrypting mechanism is included in the header portion to allow decryption of the encrypted content on the user side. Operation S14 symbolizes the combining of the header portion with the encrypted content. Block 2 depicts the protected data object succeeding operation S14. The protected data object 2 is now ready to be provided. The protected data object 2 has the typical DRM format that is specified by the Open Mobile Alliance. A header portion containing information about the corresponding content and a body portion containing at least one data portion is included in this data container. The header portion and the body portion are delimited from each other by a predefined boundary tag that is specified in RFC 2046.

FIG. 2 depicts the general data flow according to the method that generates a protected data object or a data container and its corresponding rights entity. Block 27 unifies the steps of the method described in FIG. 1. The reference symbol 1 represents the original content to be protected according to DRM protection techniques. Block 27 receives the original content and processes the steps already described according to FIG. 1. Blocks 25 and 26 symbolize the functions, which are processed inside of block 27. Block 26 shows the exact assembling of the protected data object 2 with the help of discrete data models depicted in the header portion 21 and in the body portion 22 and is also showing the MIME-type field 23. The body portion 22 corresponds to the encrypted content resulting after processing the operation S11 that is described in the previous section. Operation S12, also described above, delivers the header portion 21 in accordance with the original content. In the header portion it is defined a field for the MIME-type and additional information. The specification defining the DCF format describes exactly the entire fields included in the header portion 21. In the following itemization for the sake of completeness all fields are mentioned:
Version: Version number;
ContentTypeLen: Length of the ContentType field;
ContentURILen: Length of the ContentURI field;
ContentType: The MIME-type field 23;
ContentURI: The unique identifier of the actual content;
HeadersLen: Length of the headers field;
DataLen: Data length field;
Headers: Headers define additional meta data (encryption algorithm etc.) according to the actual content;

After processing operation S 13 the MIME-type field 23 is now blank indicating the existence of proprietary data format content. The other fields depicted in the header portion 21 contain additional information relating to the original content 1 and also information about the encryption algorithm provided to obtain the encrypted content 22. The obtained header portion containing said blank MIME-type fields together with the body portion, representing the encrypted content, are assembled to a protected data object 2.

Block 25 illustrates the generating of a rights entity in accordance with the original content is depicted. Operation S21 represents the process of generating a license entity, which defines the rights for dealing with said original content 1 on the user side. It is possible to set rights for previewing the content or for instance temporal executable rights or similar. The DRM specification exactly defines which usage rights are possible. The rights entity may be provided together with the protected data object or separately. After performing of the operation included in block 25 and 26 the protected data object 2 is now ready for distribution. Finally, the original content is encrypted and also the rights entity is generated and the content is now distributable without restrain.

FIG. 3 shows the method for providing the content which is included in a protected data object or a data container in accordance with the present invention. Generally, when a file (content) has to be used by an application (API) the DRM implementation (DRM agent) must check whether this file is a DRM protected data object or not. If the content or file are not protected another predefined operation shall be started (not part of this invention). If a protected data object is requested by an application the DRM agent manages the further handling of said object. As aforementioned, the MIME-type field included in the header portion of said protected data is adapted to provide the DRM agent with the application type capable to deal with the original content. In the case of a picture (e.g. jpeg) an image viewer shall receive the decrypted content. This means that the MIME-type field allows the DRM agent to decide which application shall deal with the content.

Another object of the present invention is to provide a method for the DRM agent to deal with proprietary (or arbitrary) data format. The proprietary data format can not be associated with a standard application like for instance the image viewer or mp3-player. The following introduces a method for dealing with proprietary data format content included in a protected data object in accordance with the present invention. The method is to be processed on the user side for instance in a mobile device. Said decryption of the encrypted content is provided inside the DRM agent in accordance with the previously obtained rights. The rights entity may be included in the protected data object but another possibility is to store the rights entity in a special data base on the user side for instance.

The API in FIG. 3 starts a data request operation S31 for using data which is included in the protected data object 2. It is assumed that the protected data object is a DRM protected data object including at least one header portion and one body portion. Next, operation 32 checks the content of the MIME-type field. S36 decides with respect to the content of the MIME-type field if a proprietary data format exists. If a standard MIME-type field was detected, according to the NO branch, a pre-defined process 1 will be started. Said pre-defined process may be a standard application like a image viewer or similar. If the MIME-type field is blank (branch YES) the existence of proprietary data format was determined and the DRM agent in accordance with this invention knows that the original application API needs the data included in the protected data object. S33 depicts the extraction of the body portion contained in the protected data object. FIG. 2 shows that the body portion also represents the encrypted content generating by means of DRM encrypting techniques. For encrypting said content a license is necessary. Operation S37 represents the decision if the license is available or not. If no license is available a pre-defined process 2 may be started which informs for instance the user that an additional rights entity is necessary. However, the user side needs a rights entity for properly dealing with the encrypted content. Operation S34 processes the decrypting of the encrypted content resulting in original content 1 that is provided to the caller API according to operation S35.

FIG. 4 shows an embodiment of the method described in FIG. 3 that is processed on the user side. Two applications API 1 and API 2 are exemplarily shown and both communicate in a bidirectional way with the DRM implementation or DRM agent in accordance with the present invention. The DRM implementation is associated with a file system 41 and a rights entity data base RE DB. Said data base may also be implemented as a standard file system or similar. The purpose of the RE DB is to provide the DRM implementation with information relating to the DRM protected content. FIG. 4 exemplarily shows a number of rights entity grouped in a special rights entity data base RE DB.

API 1 or API 2 requests a file stored in the file system. Next, if the MIME-type field corresponds to a standard MIME-type field definition an standard process is to be started after the DRM agent processes the decrypting. Whole decrypting operations are processed with respect to the stored rights entities.

API 1 demands proprietary data format content, according to S44, included in a protected data object that is stored in the file system. The DRM implementation executes the operations, which are depicted in the emphasized block of FIG. 4. S36 determines the existence of a blank MIME-type field and S33 extracts the body portion of the protected data object. Finally, the decrypting of the encrypted content in accordance with the previously obtained rights entity is performed. For encrypting information stored in the header portion of the protection data object is used as well.

After performing the encryption the DRM implementation provides the API 1 with the decrypted content 1 representing the demanded original content.

Even though the invention is described above with reference to embodiments according to the accompanying drawings, it is clear that the invention is not restricted thereto but it can be modified in several ways within the scope of the appended claims.

1. A method comprising:
obtaining an original content having a proprietary data format;
encrypting said original content resulting in an encrypted content;
generating a header portion of a protected data object associated with said encrypted content, said header portion comprising information relating to said original content, and having a MIME-type field, wherein said MIME-type field defines at least one application capable to process said original content;
assigning a blank entry to said MIME-type field of said header portion, wherein said blank MIME-type field is dedicated for indicating the existence of a proprietary data format of said original content; and
generating said protected data object by combining said header portion and said encrypted content, to be included in a body portion of said protected data object.

2. A method according to claim 1, further comprising the step of generating a rights entity associated with said original content and providing said rights entity for further usage.

3. A method according to claim 1, wherein said original content is a software application adapted to run on a mobile terminal device.

4. A method according to claim 1, wherein said protected content is freely distributable from said mobile terminal device to a plurality of mobile terminal devices.

5. A method comprising:
receiving a request from a data-requesting application for obtaining the data included in a protected data object including a MIME-type field and having a proprietary data format;
checking the content of said MIME-type field in said protected data object;
determining whether said MIME-type field of said protected data object is blank, wherein a blank MIME-type field indicates the existence of proprietary data format;
extracting an encrypted content included in a body portion of said protected data object and decrypting said encrypted content resulting in said proprietary data format content; and
providing said proprietary data format content to said data-requesting application.

6. A method according to claim 5, wherein the decrypting of said encrypted content is processed with respect to a previously obtained rights entity that is associated with said protected data object.

7. A computer program product, comprising a computer-readable medium having computer-executable program code for carrying out method of claim 1, when said program code is run on a computer, a microprocessor based device, a terminal, a network device, a mobile terminal, or a portable communication enabled terminal.

8. A computer program product, comprising a computer-readable medium having computer-executable program code for carrying out the method of claim 5, when said program code is run on a computer, a microprocessor based device, a terminal, a network device, a mobile terminal, or a portable communication enabled terminal.

9. (canceled)

10. (canceled)

11. A server unit comprising:
means for obtaining an original content having a proprietary data format;
a module for encrypting said original content resulting in an encrypted content;
a module for generating a header portion of said protected data object associated with said encrypted content, said header portion comprising information relating to said original content, and having a MIME-type field, wherein said MIME-type field defines at least one application capable to process said original content;
a module for assigning a blank entry to said MIME-type field of said header portion, wherein said blank MIME-type field is dedicated for indicating the existence of a proprietary data format of said original content; and
a module for generating said protected data object by combining said header portion and said encrypted content, to be included in a body portion of said protected data object.

12. A mobile unit comprising:
a module for receiving a request from a data-requesting application for obtaining data included in a protected data object having a MIME-type field and including a proprietary data format content;
a module for checking the content of said MIME-type field in said protected data object;
a module for determining whether said MIME-type field of said protected data object is blank, wherein said blank MIME-type field indicates the existence of proprietary data format;
a module for extracting of an encrypted content included in a body portion of said protected data object and for decrypting said encrypted content resulting in said proprietary data format content; and
a module for providing said proprietary data format content to said data-requesting application.

13. An apparatus, comprising:
means for obtaining an original content having a proprietary data format;
means for encrypting said original content resulting in an encrypted content;
means for generating a header portion of a protected data object associated with said encrypted content, said header portion comprising information relating to said original content, and having a MIME-type field, wherein said MIME-type field defines at least one application capable to process said original content;
means for assigning a blank entry to said MIME-type field of said header portion, wherein said blank MIME-type field is dedicated for indicating the existence of a proprietary data format of said original content; and
means for generating said protected data object by combining said header portion and said encrypted content, to be included in a body portion of said protected data object.

14. An apparatus, comprising:
means for receiving a request from a data-requesting application for obtaining the data included in a protected data object having a MIME-type field and including a proprietary data format content;
means for checking the content of said MIME-type field in said protected data object;
means for determining whether said MIME-type field of said protected data object is blank, wherein said blank MIME-type field indicates the existence of proprietary data format;
means for extracting of an encrypted content included in a body portion of said protected data object and for decrypting said encrypted content resulting in said proprietary data format content; and
means for providing said proprietary data format content to said data-requesting application.
